(19) United States
(12) Patent Application Publication
(10) Pub. No.: US 2020/0274116 A1
(43) Pub. Date: Aug. 27, 2020

(54) BATTERY

(71) Applicant: Techtronic Cordless GP, Anderson, SC (US)

(72) Inventors: Robert Warren, Charlotte, NC (US); William J. Kozlowski, JR., Waxhaw, NC (US)

(21) Appl. No.: 16/799,160

(22) Filed: Feb. 24, 2020

Related U.S. Application Data
(60) Provisional application No. 62/811,191, filed on Feb. 27, 2019.

(51) Int. Cl. H01M 2/10; H01M 10/42; H01M 2/02; A47L 11/40

(52) U.S. Cl. CPC H01M 2/1022; H01M 10/425; H01M 2220/30; A47L 11/4005; H01M 2/02

(57) ABSTRACT

A battery pack for selective attachment to a receptacle. The battery pack includes a housing enclosing a battery, a handle extending from the housing and defining an aperture between the housing and the handle, and a latching arrangement coupled to the housing and engageable with the receptacle for inhibiting the battery pack from being removed from the receptacle. The latching arrangement includes a latch member, a pivot member, and an actuator connected to the pivot member movable relative to the housing from a first position to a second position to move the latch member from a latched position to an unlatched position. The actuator is movable within the aperture, and the actuator forms at least a portion of the handle.

### CROSS-REFERENCE TO RELATED APPLICATIONS

This application claims priority to U.S. Provisional Patent Application No. 62/811,191, filed Feb. 27, 2019, the entire contents of which are hereby incorporated by reference herein.

### BACKGROUND

The present invention relates to battery packs, and more particularly to latching arrangements for battery packs.

### SUMMARY

In one embodiment, the invention provides a battery pack for selective attachment to a receptacle. The battery pack includes a housing enclosing a battery, a handle extending from the housing and defining an aperture between the housing and the handle, and a latching arrangement coupled to the housing and engageable with the receptacle for inhibiting the battery pack from being removed from the receptacle. The latching arrangement includes a latch member, a pivot member, and an actuator connected to the pivot member movable relative to the housing from a first position to a second position to move the latch member from a latched position to an unlatched position. The actuator is movable within the aperture, and the actuator forms at least a portion of the handle.

Other aspects of the invention will become apparent by consideration of the detailed description and accompanying drawings.

### BRIEF DESCRIPTION OF THE DRAWINGS

FIG. 1 is a perspective view of a vacuum cleaner including a battery pack according to one embodiment.

FIG. 2 is a perspective view of the battery pack of FIG. 1.

FIG. 3 is an exploded view of the battery pack of FIG. 1.

FIG. 4 is a cross-sectional view of the battery pack of FIG. 1 and illustrating the latching arrangement in a latched state.

FIG. 5 is a cross-sectional view of the battery pack of FIG. 1 and illustrating the latching arrangement in an unlatched state.

FIG. 6 is a perspective view illustrating the battery pack being removed from the vacuum cleaner of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

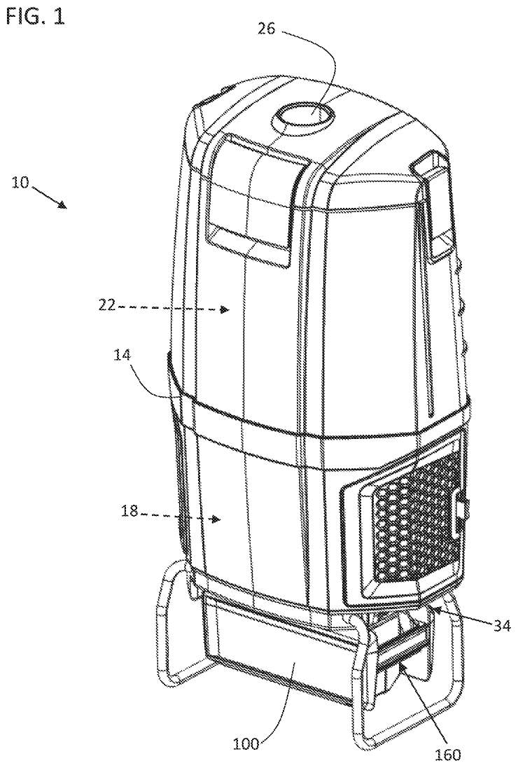

FIG. 1 illustrates a vacuum cleaner 10 including a battery pack 100 according to one embodiment. The vacuum cleaner 10 includes a main body 14 containing a suction source 18, such as an electric motor and fan assembly. A dirt separator 22 is in fluid communication with the suction source 18, and an inlet duct 26 is provided to draw air into the dirt separator 22. The dirt separator 22 filters dirt and debris from air drawn from the inlet duct 26 and can include a filter bag or one or more cyclonic separators.

The battery pack 100 includes a handle 160 configured such that as a user grasps the handle 160, an actuator 192 for unlatching the battery from the vacuum cleaner 10 is actuatable by the hand holding the handle 160, as further described below.

The illustrated vacuum cleaner 10 is a backpack-style vacuum cleaner and includes straps (not shown) coupled to the main body 14, allowing the vacuum cleaner 10 to be carried on a user's back. In other embodiments, other types and styles of vacuum cleaners can be utilized (e.g., canister, handheld, upright, utility, etc.). Furthermore, although the illustrated vacuum cleaner 10 is intended for dry surfaces, the vacuum cleaner can be configured for wet surfaces. Therefore, the term “vacuum cleaner” used herein should be understood to include carpet extractors, hard floor cleaners, and the like. Furthermore, although the battery pack 100 is described for use with a vacuum cleaner, the battery pack 100 could also be used with other powered devices such as power tools, outdoor power equipment, or any other device that utilizes a battery to power electric components such as a motor, a light, or electronics.

With continued reference to FIG. 1, the vacuum cleaner 10 further includes a receptacle 34 sized and shaped to receive the battery pack 100. The battery pack 100 is insertable into the receptacle 34 to provide power to the suction source 18 and is removable from the receptacle 34 for storage, recharging, replacement, and the like. The receptacle 34 need not be used with the vacuum cleaner 10, however. For example, the receptacle 34 could be provided on any of the other powered devices listed above. In other embodiments, the receptacle 34 could be provided on a battery charger. In addition, although the illustrated receptacle 34 receives the battery pack 100 therein such that the battery pack 100 is substantially surrounded by the receptacle 34, in other embodiments, the receptacle 34 can be located on any face of the vacuum cleaner 10 or other powered device. Thus, the receptacle 34 need not encapsulate the battery pack 100, but may only receive a portion of the battery pack 100.

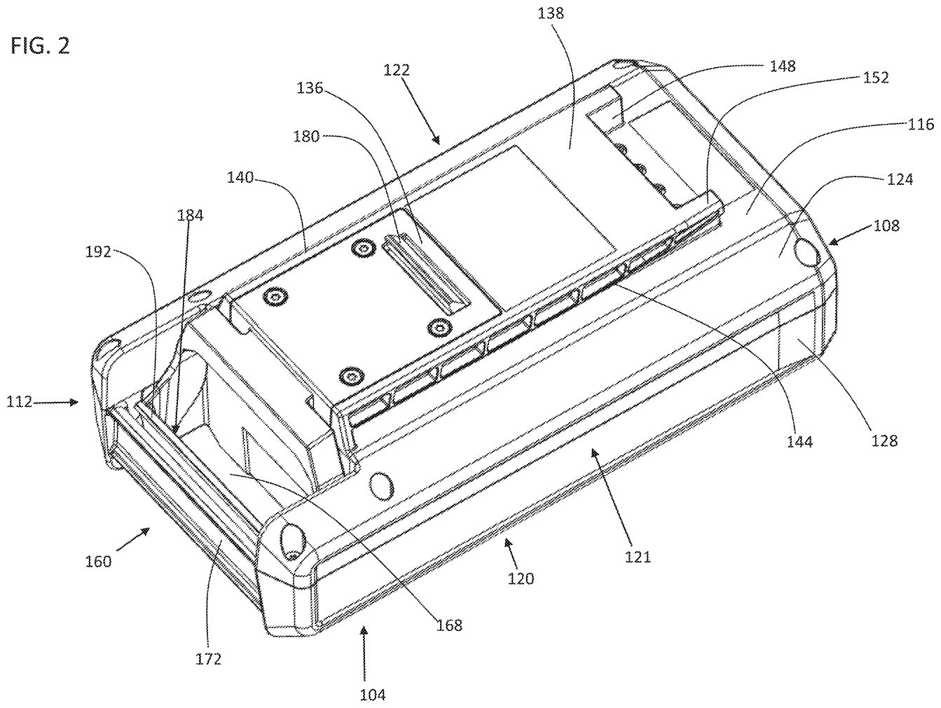

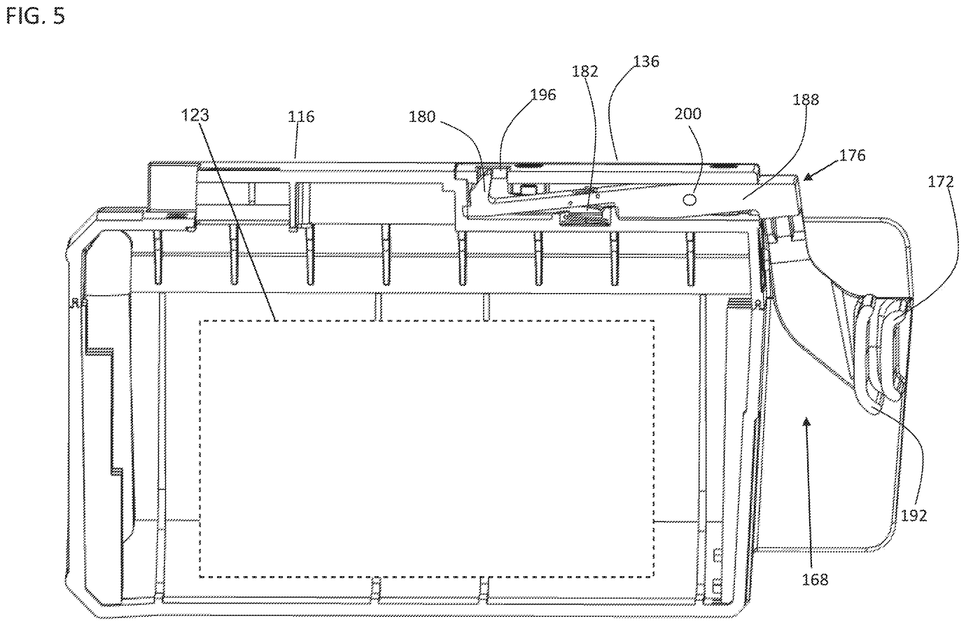

With reference to the orientation of FIG. 2, the battery pack 100 includes a housing 104 having a front side 108, a back side 112, a top side 116, a bottom side 120, and sides 121, 122. The housing 104 encloses a battery 123 (FIG. 5), which typically includes one or more rechargeable cells. The cells can be arranged in series, parallel, or a series-parallel combination to provide a desired nominal voltage and capacity. In the illustrated embodiment, the battery 123 has a nominal voltage of about 40 volts. In some embodiments, the battery 123 is a lithium-ion type battery, having a lithium-based cells with a chemistry of, for example, lithium-cobalt, lithium-manganese, or lithium-manganese spinel. Alternatively, the cells can have any other suitable chemistry and any desired nominal voltage.

The illustrated housing 104 includes first and second cooperating housing portions 124, 128 that can be coupled together by any suitable means, such as by fasteners, adhesives, ultrasonic welding, a snap-fit, and the like. The first housing portion 124 defines the top side 116 of the battery pack 100, and the second housing portion 128 defines the bottom side 120 of the battery pack 100. In other embodiments, the housing 104 can include more than two housing portions. Alternatively, elements of the housing 104 can be formed as a single, unitary piece.

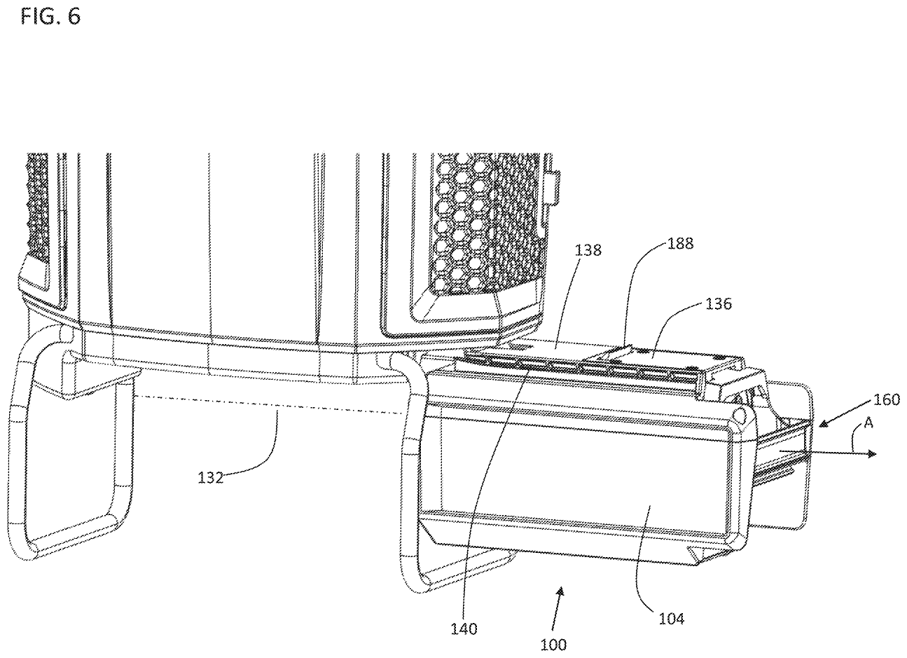

Referring to FIG. 6, the housing 104 defines a longitudinal insertion axis 132 along which the battery pack 100 is slideable to insert or remove the battery pack 100 from the receptacle 34. The axis 132 extends through the front side 108 and the back side 112 of the housing 104. The battery pack 100 is movable in a forward direction along the insertion axis 132 to insert the battery pack 100 into the receptacle 34 and in a rearward direction (i.e., in the direction of arrow A) along the insertion axis 132 to remove the battery pack 100 from the receptacle 34.

Referring again to FIG. 2, the battery pack 100 further includes a rail arrangement 138 extending along one side, such as the top side 116 to facilitate coupling the battery pack 100 to the receptacle 34. The rail arrangement 138 includes first and second guide rails 140, 144, each extending along the housing 104 in a direction parallel to the insertion axis 132. Each of the illustrated guide rails 140, 144 is generally L-shaped, having a first wall 148 extending generally perpendicularly from the top side 116 and a second wall 152 extending generally perpendicularly from the first wall 148. The guide rails 140, 144 are sized and shaped to engage a corresponding rail arrangement (not shown) provided on the receptacle 34. In one embodiment, the rail arrangement 138 also houses electrical connectors (not shown) at its front end. The electrical connectors mate with corresponding connectors (not shown) provided on the receptacle 34 to permit electrical communication between the battery pack 100 and the receptacle 34 when the battery pack 100 is coupled to the receptacle 34.

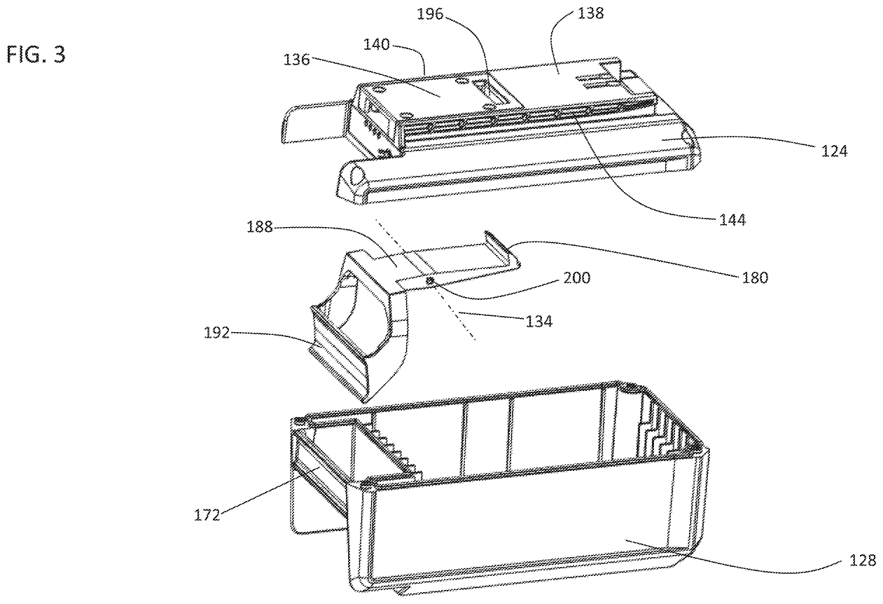

With reference to FIGS. 2-3, the battery pack 100 further includes a handle 160 extending from the back side 112 of the housing 104. The handle 160 includes a grip portion 184. In the illustrated embodiment, the grip portion 184 is transverse to the insertion axis 132, however in other embodiments the grip portion 184 may be along the insertion axis, or may include other variations. The handle 160 defines an aperture 168 between the housing 104 and the handle 160. The aperture 168 is sized to receive at least a portion of a user's hand such that the user can grasp the handle 160. As such, in some embodiments the aperture 168 can have a length (measured transverse to the insertion axis 132) between about 1 inch and about 6 inches, and the aperture 168 can have a width (measured along the insertion axis 132) between about ¾ inch and 3 inches.

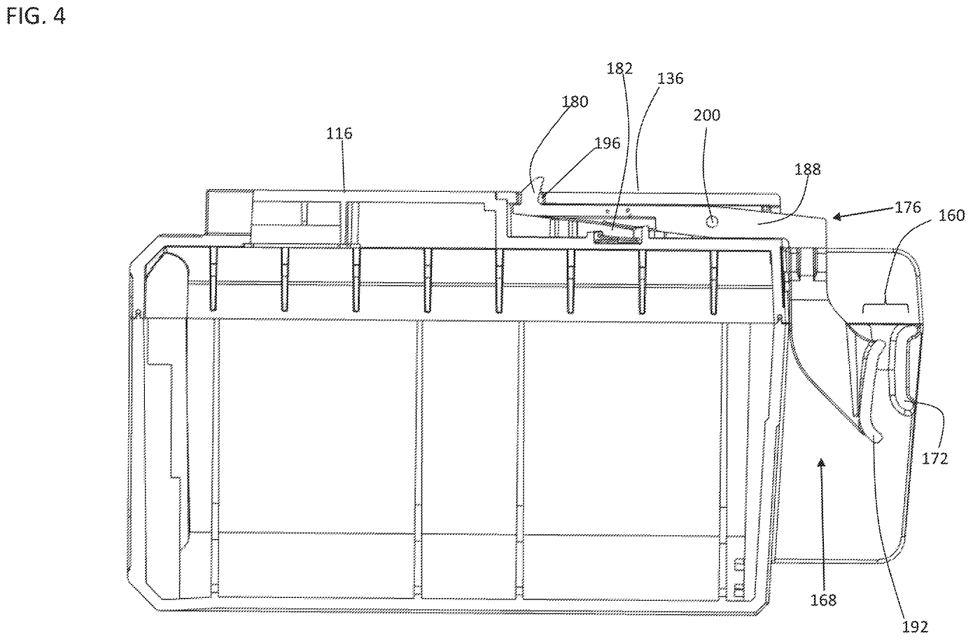

Referring to FIGS. 4-5, the battery pack 100 includes a latching arrangement 176 coupled to the housing 104. The latching arrangement 176 is engageable with the receptacle 34 to inhibit the battery pack 100 from being removed from the receptacle 34. The latching arrangement 176 includes a latch member 180, a pivot member 188 movable about a pivot 200, and an actuator 192. The latch member 180 extends through an opening 196 in a latch surface 136. The latch surface 136 may be adjacent or along the top surface 116 as illustrated in FIG. 2. In one embodiment, the latch surface 136 may be adjacent or along the bottom surface 120 or one of the sides 121, 122 as desired for engagement with the configuration of the receptacle 34. Although the illustrated latching arrangement 176 includes one latch member 180, in other embodiments, the latching arrangement 176 may be configured for two latch members or more than two latch members. As described in greater detail below, the pivot member 188 is movable relative to the housing 104 from a first position to a second position to move the latch member 180 from a latched position (FIG. 4) to an unlatched position (FIG. 5). In the illustrated embodiment, the latching arrangement 176 includes a spring 182. In the first position the spring 182 presses the latch member 180 towards the latched position. The pivot member 188 compresses the spring 182 when moving the latch member 180 to the unlatched position.

The pivot member 188 pivots around the pivot 200 to move from the first position to the second position. The pivot 200 defines a pivot axis 134 that is transverse to the insertion axis 132 when the battery pack 100 is coupled with the receptacle 34. In the illustrated embodiment, the pivot axis 134 is generally parallel to the handle 160, however in other embodiments the orientation of the pivot axis 134 may be perpendicular to the handle 160, or may include another variation. In the illustrated embodiment, the pivot member 188 and the latch member 180 are integrally formed. In an alternate embodiment, the pivot member 188 and the latch member 180 may be separately formed. In the illustrated embodiment, the latch member 180 moves in a direction transverse to the pivot axis. In one embodiment, the pivot member 188 presses a cam surface to move the latch member 180 in a direction along the pivot axis 134.

As shown in FIG. 4, the pivot member 188 is connected to the actuator 192, which is movable within the aperture 168 in response to user actuation. In the illustrated embodiment, the actuator 192 is a lever, however the actuator could be a button, tab, grip, or other user-actuated member connected to the pivot member 188. In the illustrated embodiment, the support member 172 is connected to the housing 104 at the back end 112. The actuator 192 is adjacent the support member 172, extending into the aperture 168. In the illustrated embodiment, the support member 172 and the actuator 192 form the grip portion 184 of the handle 160, which defines one end of the aperture 168. In one embodiment, the support portion 172 is omitted and the actuator 192 is the handle 160.

The actuator 192 is movable between an actuator first position and an actuator second position in response to user actuation. In the illustrated embodiment, the actuator 192 is moved from the first position to the second position by the user moving the actuator 192 generally along the insertion axis 132 toward the support member 172 as a result of the actuator 192 pivoting about pivot 200. In an alternate embodiment, the actuator 192 is moved from the first to the second position by the user moving the actuator 192 in a direction transverse to the insertion axis 132. The movement of the actuator 192 from its first position to second position may be along the insertion axis 132 in a direction away from the receptacle 34 such that a user can pull the battery from the receptacle 34 as the latch member 180 unlatches by actuation of the pivot member 188. Moving the actuator 192 from the actuator first position to the second position correspondingly moves the pivot member 188 about the pivot 200, between the pivot member first and second positions.

With reference to FIG. 4, when the latching arrangement 176 is in a latched state, the latch member 180 extends through the opening 196 in the latch surface 136 of the housing 104 to engage with a corresponding recess (not shown) in the receptacle 34, thereby inhibiting removal of the battery pack 100 from the receptacle 34. To unlatch the battery pack 100, a user puts his or her fingers through the aperture 168 to grasp the support portion 172 of the handle 160. Next, the user pulls in the removal direction applying force against the actuator 192 moving the actuator 192 to the second position pivoting the pivot member 188 about the pivot 200, such that the latch member 180 retracts below the opening 196 of the latch surface 136. Accordingly, the latch member 180 disengages from the receptacle 34. The user can then pull on the handle 160 in the direction of arrow A to withdraw the battery pack 100 from the receptacle (FIG. 6).

Because the actuator 192 is easily accessible with the handle 160, the user can actuate the latching arrangement 176 with the same hand used to grasp the handle 160, allowing the battery pack 100 to be unlatched and withdrawn from the receptacle 34 with one hand. Additionally, the position of the actuator 192 allows the user to grab the actuator 192 and remove the battery pack 100 with a single pulling motion in the removal direction A along the insertion axis 132. The handle 160 also provides a convenient means to carry the battery pack 100 when it is separated from the receptacle 34.

Various features and advantages of the invention are set forth in the following claims.

What is claimed is:

1. A battery pack for selective attachment to a receptacle, the battery pack comprising:
a housing enclosing a battery, the housing defining an insertion axis along which the battery pack is insertable into the receptacle;
a handle extending from the housing and defining an aperture between the housing and the handle;
a latching arrangement coupled to the housing and engageable with the receptacle for inhibiting the battery pack from being removed from the receptacle, the latching arrangement including
a latch member,
a pivot member pivotable relative to the housing about a pivot axis to move the latch member from a latched position to an unlatched position, and
an actuator connected to the pivot member and movable within the aperture between a first position in which the latch member is in the latched position and a second position in which the latch member is in the unlatched position;
wherein the actuator forms at least a portion of the handle.

2. The battery pack of claim 1, wherein the pivot axis is transverse to the insertion axis.

3. The battery pack of claim 1, wherein the latch member is movable between the latched position and the unlatched position in a direction transverse to the pivot axis.

4. The battery pack of claim 1, wherein the latch member is connected to and pivotable with the pivot member about the pivot axis.

5. The battery pack of claim 1, wherein the latch member is integral with the pivot member.

6. The battery pack of claim 1, wherein the handle includes a support portion, wherein the actuator moves within the aperture toward the support portion when the actuator moves from the first position toward the second position.

7. The battery pack of claim 6, wherein the actuator and the support portion form the handle.

8. The battery pack of claim 1 wherein the handle includes a grip portion extending transverse to the insertion axis.

9. The battery pack of claim 8 wherein the actuator forms a portion of the grip portion.

10. The battery pack of claim 1, further comprising a guide rail extending parallel to the insertion axis, wherein the latch member is movable between the latched position and the unlatched position in a direction transverse to the insertion axis.

11. The battery pack of claim 10, where the guide rail is a first guide rail, and further comprising a second guide rail positioned opposite the first guide rail and a latch surface between the first and second guide rails, wherein the latch member extends from an opening in the latch surface when in the latched position.

12. The battery pack of claim 1, wherein the pivot member includes a pivot, and wherein the pivot is located inside the housing.

13. The battery pack of claim 1, wherein the housing includes a front side and a back side opposite the front side, wherein the handle is adjacent the back side, and wherein the insertion axis extends through the front side and the back side.
